(19) United States
(12) Patent Application Publication
(10) Pub. No.: US 2025/0188322 A1
(43) Pub. Date: Jun. 12, 2025

(54) Curable adhesive substance with improved punchability

(71) Applicant: TESA SE, Norderstedt (DE)

(72) Inventors: Christian SCHUH, Hamburg (DE); Carl DITTMER, Hamburg (DE)

(21) Appl. No.: 18/845,277

(22) PCT Filed: Mar. 1, 2023
(86) PCT No.: PCT/EP2023/055117

§ 371 Date: Sep. 9, 2024

(30) Foreign Application Priority Data
Mar. 11, 2022 (DE) 102022105738.0

(51) Int. Cl. C09J 7/38; C09J 133/08; C09J 163/00

(52) U.S. Cl. CPC C09J 7/387; C09J 133/08; C09J 163/00

(57) ABSTRACT

The invention relates to a curable adhesive substance comprising the following, in relation to the mass of the curable adhesive substance: a) one or more (meth)acrylate block copolymers X with an A-B-A structure in a combined mass fraction of 20% or more, wherein the A blocks independently represent a poly(meth)acrylate with a glass transition temperature Tg of 50° C. or more, which can be produced by polymerising an A monomer composition formed of A monomers, wherein the B block represents a poly(meth)acrylate with a glass transition temperature Tg of less than 50° C., which can be produced by polymerising a B monomer composition formed of B monomers; and b) one or more polymerisable compounds Y in a combined mass fraction of 20% or more, and wherein, for the polar fractions (weighted by substance amount) of the Hansen solubility parameters <δp>: i) of the monomer units in the A blocks <δp>(A) derived from A monomers, ii) of the monomer units in the B block <δp>(B) derived from B monomers, and iii) of the polymerisable compounds Y <δₚ>(Y), the following is true: −|<δₚ>(A)−<δₚ>(Y)|>3.5 MPa^{0.5}, and −|<δₚ>(B)−<δₚ>(Y)|<3.5 MPa^{0.5}.

The invention relates to a curable adhesive compound and to a reactive adhesive tape comprising such a curable adhesive compound. Additionally disclosed are the use of such curable adhesive compound and reactive adhesive tapes for bonding two or more components and a method for producing such curable adhesive compounds.

The joining of separate elements is one of the central methods in manufacturing. In addition to other methods, such as welding and soldering, for example, adhesive bonding, i.e. joining using an adhesive, is of particular importance nowadays. An alternative here to the use of formless adhesives which are applied from a tube, for example, are so-called adhesive tapes. From everyday life, pressure-sensitive adhesive tapes in particular are known, in which the adhesive effect is ensured by a pressure-sensitive adhesive, which is permanently tacky and adhesive under normal ambient conditions. Corresponding pressure-sensitive adhesive tapes can be applied to a substrate by means of pressure and remain adhering there, but can later be removed in a more or less residue-free manner.

However, another type of adhesive tape is also of great importance, especially for use in industrial manufacturing. These adhesive tapes, which are sometimes also referred to as reactive adhesive tapes, use a curable adhesive. Appropriate curable adhesives have not yet reached their maximum degree of crosslinking in the state intended for application and can be cured by external influences, by initiating the polymerization in the curable adhesive and thereby increasing the degree of crosslinking. The mechanical properties of the now cured adhesive change here, with the viscosity, surface hardness and strength increasing in particular.

Curable adhesives are known in the art and can have very different compositions from a chemical point of view. These curable adhesives have in common that the crosslinking reaction can be triggered by external influencing factors, by supply of energy, for example, in particular by temperature, plasma or radiation curing, and/or by contact with a polymerization-promoting substance, as is the case, for example, with moisture-curing adhesives. Corresponding adhesives are disclosed, for example, in DE 102015222028 A1, EP 3091059 A1, EP 3126402 B1, EP 2768919 B1, DE 102018203894 A1 and WO 2017174303 A1, U.S. Pat. No. 4,661,542 A.

The curability of corresponding curable adhesives is achieved generally by the use of polymerizable compounds, in particular of crosslinkable monomers or oligomers. These low molecular mass polymerizable compounds, which in order to ensure sufficient curing must usually be used in a significant mass fraction, are also sometimes referred to by the skilled person as reactive resins.

The low molecular mass reactive resins typically used are generally liquids with a low viscosity. In combination with the high mass fraction in curable adhesives, this means that corresponding curable adhesives generally themselves have a low viscosity. This means that the processing properties of many curable adhesives from the prior art are perceived to be insufficient and that a comparatively high effort must be made in the typical processing methods of the adhesive industry in order to process curable adhesive rationally. In addition to the dimensional stability of the pressure-sensitive adhesives in the winding of adhesive tapes, the diecuttability in particular, i.e. the suitability for singulation of adhesive elements by means of a diecutting process, is generally evaluated as insufficient.

In order to ensure best-possible processability for the end user, it is generally desirable even for curable adhesives to have at least weakly pronounced pressure-sensitive adhesive properties themselves. In particular, it is desirable that reactive adhesive tapes can be removed before curing if necessary, substantially without residue, if for example there was defective application of an adhesive tape. However, the properties of curable adhesives that are governed by the high mass fraction of reactive resin often result in insufficient cohesion in the curable adhesive. In many cases, instead of the desired adhesive failure on the substrate, a cohesive failure can occur, leaving residues of the adhesive on the substrate.

In the light of the observations above, there is a continued interest in the field of adhesive technology in improving the processing properties of curable adhesives, in particular for improving the diecuttability and increasing the cohesion in the material.

The measures known from the prior art for increasing the cohesion and/or for reducing the viscosity of the curable adhesives, however, in many cases worsen the later handling properties of the reactive adhesive tapes, since the flow-on behaviour desired in the application, i.e. the conformance of the curable adhesive of the reactive adhesive tape to the structure of the substrate, in particular on rough substrate surfaces, is also adversely affected, and so, after curing, a peel adhesion that does not meet the specified requirements may be achieved because of insufficient contact with the substrate. Against this background, in the field of curable adhesives, there is generally a conflict of objectives between a sufficient cohesion in the curable adhesive and its processing properties in the production of adhesive tapes, on the one hand, and the handling and adhesive properties of the resulting reactive adhesive tapes, on the other.

The primary object of the present invention was to eliminate or at least reduce the above-described disadvantages of the prior art.

In particular, the object of the present invention was to provide a curable adhesive compound in which the conflict of objectives described above between a high cohesion and good processability of the adhesive compound, in particular good diecuttability, on the one hand, and the handling properties and the achievable peel adhesion of the reactive adhesive tape, on the other hand, is resolved in the best-possible way.

In this respect, the object of the present invention was to specify a curable adhesive compound which, despite large mass fractions of reactive resin, shows sufficient cohesion to achieve a substantially adhesive failure in subsequent use on detachment from the substrate.

It was an object of the present invention that the curable adhesive compounds to be specified should have an advantageous flow-on behaviour and should achieve excellent peel adhesion even on substrates with rough surfaces after curing.

It was a further object of the present invention that the curable adhesive compounds to be specified should have an excellent shock resistance in the cured state.

In this context, it was a supplementary object of the present invention that the pressure-sensitive adhesives to be specified should ideally be producible as far as possible using starting materials and processes which are already used in the field of adhesive technology, in order to permit time- and cost-efficient production.

It was a supplementary object of the present invention to provide an advantageous reactive adhesive tape or pressure-sensitive adhesive tape.

In addition, it was a secondary object of the present invention to provide a use of the curable adhesive compounds or reactive adhesive tapes to be specified for bonding two or more components and a method for producing corresponding curable adhesive compounds.

The inventors of the present invention have now found that the objects described above can be achieved surprisingly if in curable adhesive compounds with a comparatively large mass fraction of reactive resins, significant amounts of a (meth)acrylate block copolymer of the general formula A-B-A are used in which the A and B blocks are specifically selected and precisely matched to the reactive resin in terms of their polarity, as defined in the claims.

The objects stated above are thus solved by the subject matter of the invention as defined in the claims. Preferred configurations according to the invention result from the dependent claims and the observations below.

Embodiments which are hereinafter designated as preferred are combined in particularly preferred embodiments with features of other embodiments designated as preferred. Very particularly preferred, therefore, are combinations of two or more of the embodiments designated below as particularly preferred. Also preferred are embodiments in which a feature of one embodiment that is designated in any degree as preferred is combined with one or more further features of other embodiments that are designated in any degree as preferred. Features of preferred adhesive tapes, uses and methods result from the features of preferred curable adhesive compound.

Insofar as subsequently for an element, for example for the (meth)acrylate block copolymers or a particular monomer, both specific amounts or fractions of this element and preferential configurations of the element are disclosed, the disclosure is also in particular of the specific amounts or fractions of the preferentially configured elements. In addition, it is disclosed that with the corresponding specific total amounts or total fractions of the elements, at least a part of the elements can be preferably configured and in particular also that preferably configured elements within the specific total amounts or total fractions may in turn be present in the specific amounts or fractions.

The invention relates to a curable adhesive compound comprising, based on the mass of the curable adhesive compound:
a) one or more (meth)acrylate block copolymers X of structure A-B-A in a combined mass fraction of 20% or more,
wherein the A blocks independently of each other are a poly(meth)acrylate having a glass transition temperature Tg of 50° C. or more, which is producible by polymerization of an A monomer composition of A monomers,
wherein the B block is a poly(meth)acrylate having a glass transition temperature Tg of less than 50° C., which is producible by polymerization of a B monomer composition of B monomers, and
b) one or more polymerizable compounds Y in a combined mass fraction of 20% or more, and
wherein the polar fractions, weighted for amount of substance, of the Hansen solubility parameters <δₚ>:
i) of the monomer units derived from A monomers in the A blocks <δₚ>(A),
ii) of the monomer units derived from B monomers in the B block <δₚ>(B), and
iii) of the polymerizable compounds Y <δₚ>(Y),
are subject to:

$$\vert 〈 {δ}_{p} 〉 ( A ) - 〈 {δ}_{p} 〉 ( Y ) \vert > 3.5 {MPa}^{0.5} , and \\ \vert 〈 {δ}_{p} 〉 ( B ) - 〈 {δ}_{p} 〉 ( Y ) \vert < 3.5 {MPa}^{0.5} .$$

Here, the purely characterizing additions X and Y serve for clearer delimitation from the A and B blocks and also for easier reference. These above-defined constituents are each used as “one or more” in accordance with the skilled understanding. The term “one or more” refers, in a manner usual in the sector, to the chemical nature of the compounds in question and not to the amount of substance thereof. For example, the curable adhesive compound may comprise as polymerizable compounds Y exclusively epoxycyclohexylmethyl 3′,4′-epoxycyclohexanecarboxylate, which would mean that the monomer composition comprises a multiplicity of the corresponding molecules.

In a customary manner, the mass fractions are specified as combined mass fractions of the one or more components, thus expressing that the mass fraction of the correspondingly embodied components taken together meets the corresponding criteria, where for the (meth)acrylate block copolymers X and the polymerizable compounds Y, respectively, the mass of the curable adhesive compound is the reference system.

The curable adhesive compound of the invention is curable. Owing to the possibility for curing, the curable adhesive compound can act as a structural adhesive after curing. According to DIN EN 923:2006-01, structural adhesives are adhesives that form adhesive bonds that can maintain a specified strength in a structure for a mandated, relatively long period of time (according to ASTM definition: “bonding agents used for transferring required loads between adherends exposed to service environments typical for the structure involved”). They are therefore adhesives for highly chemically and physically stressable bonds that contribute to the strengthening of the adhesive tapes in the cured state.

Block copolymers in general and (meth)acrylate block copolymers in particular are fundamentally known from the prior art, including particularly block copolymers with the structure A-B-A. The production of (meth)acrylate block copolymers, for example of the A-B-A structure, is described in the prior art, and for the presently employed (meth)acrylate block copolymers too, the methods known from the prior art for block copolymerization can be used in principle. An illustrative overview of block copolymers that are used for various purposes, including in various adhesive compounds, is found for example in the documents US2011003947 A1, US 20080200589 A1, US2007078236 A1, US2007078236 A1, US2012196952 A1, US2016032157 A1, US2008146747 A1 and US2016230054 A1.

In the (meth)acrylate block copolymers X of structure A-B-A to be used according to the invention, the A blocks have a higher glass transition temperature than the B blocks. Based on the terminology used in some cases for other block copolymers, the A blocks are sometimes also referred to as hard blocks, whereas the B block is also referred to as soft block. In this respect, however, it should be noted that for the (meth)acrylate block copolymers identified by the inventors, according to the inventors' assessment, higher glass transition temperatures can in principle be provided in the B block as well than for some of the soft blocks known from the prior art. In accordance with the skilled understanding, the glass transition temperature of the A blocks or the B block is determined not on the (meth)acrylate block copolymer X, but on the isolated (co) polymers of the respective blocks.

In the context of the present invention, the glass transition temperature of polymers or of polymer blocks in block copolymers is determined by means of differential scanning calorimetry (DSC), as described in DIN EN ISO 11357. To do this, around 5 mg of an untreated polymer sample are weighed out into an aluminium crucible (volume 25 L) and closed with a perforated lid. A DSC 204 F1 from Netzsch is used for the measurement. Work is carried out under nitrogen for inerting. The sample is first cooled to −150° C., then heated at a heating rate of 10 K/min to +150° C. and cooled again to −150° C. The subsequent second heating curve is run again at 10 K/min, and the change in the heat capacity is recorded. Glass transitions are recognized as steps in the thermogram. The determination of the glass transition temperature from the DSC measurements is unproblematic for the skilled person and is described in more detail in EP 2832811 A1, for example.

The two A blocks of the (meth)acrylate block copolymers X are characterized by a common criterion for the glass transition temperature and by the joint producibility from the same A monomers. The skilled person understands that the A blocks exhibit a great similarity due to their production, owing to the nature of the polymerization processes used for the production, in particular when using two or more different A monomers, but do not need to be exactly identical. Similarly to the A and B blocks, this also applies to the (meth)acrylate block copolymers themselves, since the skilled person in the field of polymeric materials would describe block copolymers which differ from each other with respect to the A and B blocks only within the bounds of production-related variation as a common material, i.e. as a (meth)acrylate block copolymer.

In accordance with the skilled understanding and the usual procedure in the field of the art, it is useful to define polymeric and oligomeric compounds such as the A blocks and the B block via the production process or the starting materials used for the production, since it is impossible to define the corresponding materials rationally in a different way.

In the curable adhesive compounds of the invention, (meth)acrylate block copolymers X are used, which consist of poly(meth)acrylate blocks. These (meth)acrylate block copolymers X thus consist at least in part of assemblies derived from (meth)acrylate monomers, with the term “(meth)acrylate” in accordance with the skilled understanding embracing acrylates and methacrylates. It is preferred accordingly if the (meth)acrylate block copolymers and the corresponding blocks have been produced predominantly or even substantially completely from (meth)acrylate monomers.

Within the scope of the present invention, the term “poly(meth)acrylates” embraces polyacrylates and polymethacrylates and also copolymers of these polymers, in accordance with the skilled understanding. Poly(meth)acrylates may contain smaller amounts of monomer units that are not derived from (meth)acrylates. A “poly(meth)acrylate” in the context of the present invention is accordingly understood to mean a (co) polymer for which the monomer base consists to a mass fraction of 70% or more, preferably 90% or more, particularly preferably 98% or more, of monomers selected from the group consisting of acrylic acid, methacrylic acid, acrylic acid esters and methacrylic acid esters, based on the mass of the monomer base. Preferably, the mass fraction of acrylic acid esters and/or methacrylic acid esters is 50% or more, particularly preferably 70% or more. Poly(meth)acrylates are generally accessible by radical polymerization of acrylic- and/or methacrylic-based monomers and, optionally, other copolymerizable monomers.

The production of such poly(meth)acrylates from the respective monomers can be carried out according to the usual methods, in particular by conventional radical polymerizations or controlled radical polymerizations, for example anionic polymerization, RAFT, NMRP or ATRP polymerization. The polymers or oligomers can be prepared by copolymerization of the monomeric components using the usual polymerization initiators and optionally chain transfer agents, where polymerization may be performed at the usual temperatures, for example, in bulk, in emulsion, e.g. in water or liquid hydrocarbons, or in solution. Preferably, the poly(meth)acrylates are prepared by polymerization in solvents, particularly preferably in solvents having a boiling temperature in the range from 50 to 150° C., particularly preferably in the range from 60 to 120° C., using the usual amounts of polymerization initiators, the polymerization initiators being added to the monomer composition generally in a fraction of about 0.01% to 5%, in particular from 0.1% to 2%, based on the mass of the monomer composition.

Suitable polymerization initiators are, for example, radical sources such as peroxides, hydroperoxides and azo compounds, e.g. dibenzoyl peroxide, cumene hydroperoxide, cyclohexanone peroxide, di-t-butyl peroxide, cyclohexylsulfonyl acetyl peroxide, diisopropyl percarbonate, t-butyl peroctoate, or benzopinacol. Particularly preferably, 2,2′-azobis(2-methylbutyronitrile) or 2,2′-azobis(2-methylpropionitrile) is used as the radical polymerization initiator. In particular, alcohols such as methanol, ethanol, n- and iso-propanol, n- and iso-butanol, preferably isopropanol and/or isobutanol, and also hydrocarbons such as toluene and in particular benzines with a boiling temperature in the range from 60 to 120° C., are candidates for solvents. In particular, ketones, such as acetone, methyl ethyl ketone and methyl isobutyl ketone, and esters, such as ethyl acetate, for example, and also mixtures of these solvents, may be used.

The curable adhesive compound of the invention comprises polymerizable compounds Y. The polymerizable compounds Y in the curable adhesive compound together form the part of the curable adhesive compound which is often referred to by the skilled person as reactive resin. The term “polymerizable” refers in accordance with the skilled understanding to the ability of the polymerizable compounds, where necessary after appropriate activation, to enter into a polymerization reaction. In many cases, polymerizability is enabled, for example, by ethylenically unsaturated groups. However, the polymerizability can also result from the presence of two or more polymerizable compounds Y which can be jointly polymerized, for example by a polyaddition or a polycondensation. An example would be the combination of epoxides with dicyandiamide and/or imidazoles.

In the curable adhesive compound of the invention, the polarity of the A and B blocks is now specifically attuned to the polarity of the polymerizable compounds Y. This is done by adjusting the so-called polar fraction of the Hansen solubility parameters, the background of which is explained in more detail below. For the basic understanding of the invention, it must first be sufficiently recognized at this point that the A blocks must differ significantly in their polarity from the polarity of the polymerizable compound Y, this being expressed presently by the amount of the difference between the corresponding polar fractions of the Hansen solubility parameters of monomer units derived from A monomers in the A blocks and those of the polymerizable compounds Y being greater than 3.5 MPa^{0.5}. The definition via the amount of the difference is useful in this respect, as both a positive and a negative deviation is possible, provided that it is only sufficiently large in terms of amount.

In clear contrast, the polarity of the B blocks should be as close as possible to the polarity of the reactive resin, i.e. of the polymerizable compounds Y, which is defined presently by the difference between the polar fraction of the Hansen solubility parameters of the monomer units derived from B monomers in the B block and the corresponding value of the polymerizable compounds Y having to be less than 3.5 MPa^{0.5} in terms of amount.

The inventors have recognized that this specific adaptation of the (meth)acrylate block copolymers to the reactive resin used leads to an optimal solution of the conflict of objectives defined above, with a curable adhesive compound with excellent processing properties and sufficient cohesion being obtained, which nevertheless has a good flow-on behaviour even on rough substrates and shows an advantageous peel adhesion after curing. The curable adhesive compounds have excellent shock resistance.

Without wanting to be bound by this theory, the inventors assume that the adjustment of the polarities described above results in the B block of the (meth)acrylate block copolymers having particularly good solubility in the reactive resins used, whereas the A blocks have an especially low solubility in the reactive resin, which more particularly is significantly below the solubility of A blocks known from the prior art and which, according to the inventors' assessment, is responsible for the advantageous cohesion of the curable adhesive compound, whereas the readily soluble B block ensures the uptake of the (meth)acrylate block copolymers into the reactive resins and thus the sufficient compatibility.

The concept of the Hansen solubility parameters, their background and their calculation are now explained below, along with illustrative values for those monomers that are regularly used in the field of adhesive technology.

A description of solubility parameters known in the literature is made by means of the one-dimensional Hildebrand parameter (δ). However, these one-dimensional δ values are subject to errors that are often large with polar compounds such as (meth)acrylates or those that can form hydrogen bonds, such as acrylic acid, for example. Since the model of the one-dimensional Hildebrand solubility parameters therefore finds only limited use, Hansen developed it further (cf. Hansen Solubility Parameters: A User's Handbook, Second Edition; Charles M. Hansen; 2007 CRC Press; ISBN 9780849372483).

These Hansen solubility parameters, which are widely used today, are three-dimensional solubility parameters, which are often used in particular in the area of the formulation of adhesive compounds, as disclosed, for example, in WO 2019/106194 A1 or WO 2019/229150 A1. They consist of a disperse fraction (δ_{d}), a fraction arising from polar interactions (δₚ) and a fraction for the hydrogen bonds (δₚ). The Hansen solubility parameters are related to the Hildebrand parameter δ as follows:

$${δ}^{2} = {δ}_{d}^{2} + {δ}_{p}^{2} + {δ}_{H}^{2} .$$

The values for δ_{d}, δₚ and δ_{H} cannot be experimentally determined directly for poly(meth)acrylates, but can be calculated using increment systems. A common method also used in the context of the present invention is the Stefanis/Panayiotou method (“Prediction of Hansen Solubility Parameters with a New Group-Contribution Method”; Int. J. Thermophys. (2008) 29:568-585; Emmanuel Stefanis, Costas Panayiotou).

In accordance with the Stefanis/Panayiotou group contribution method, the solubility parameters of the monomer units in the polymers attributable to the individual monomers, i.e. those of the repeating unit in a polymer chain (i.e. where necessary without the polymerizable double bond of the monomers, instead taking into account a covalent s bond as is present in the polymer chain), are used to determine the Hansen solubility parameters for polymers, according to the protocol in the stated text. For each group in the building block, a specific value for the disperse fraction (Od), the fraction of polar interactions (δₚ) and the hydrogen bonding fraction (OH) is tabulated; see “Prediction of Hansen Solubility Parameters with a New Group-Contribution Method”; Int. J. Thermophys. (2008), Tables 3 to 6, pages 578 to 582.

For example, polyacrylic acid contains the repeating unit:

-[—CH₂—CHC(O)OH—]ₙ—.

According to the increment system of Stefanis/Panayiotou, the Hansen solubility parameters (a CH₂ group, a CH group and a COOH group) for the corresponding building block are δ_{d}=17.7, δₚ=8.6 and δ_{H}=11.1.

For example, polybutyl acrylate contains the repeating unit:

-[—CH₂—CHC(O)O(CH₂)₃CH₃—]ₙ—.

With four CH₂ groups, a CH group, a COO group and a CH₃ group, the Hansen solubility parameters for the corresponding building block are δ_{d}=17.1, δₚ=8.6 and δ_{H}=6.5.

In the group contribution method according to Stefanis and Panayiotou, more complex organic molecules are described using so-called first and second order groups. The first order groups (n) represent the basic molecular structure. The second order groups (m) take into account the conjugation of the first order groups and increase the accuracy of the method.

According to the inventors' knowledge, for the present invention, only the polar fractions δₚ are to be taken into account. These can be calculated according to the following formula:

$${δ}_{p} = ( {\sum }_{i} {N}_{i} {C}_{i} + {\sum }_{j} {M}_{j} {D}_{j} + 7.3548 ) {MPa}^{0.5} .$$

Tables 1 and 2 show exemplary calculations for two illustrative reactive resins (epoxycyclohexylmethyl 3′,4′-epoxycyclohexanecarboxylate and 2-hydroxy-3-phenoxypropyl acrylate).

TABLE 1
Calculation of the polar fraction of the Hansen
solubility parameters δₚ for epoxycyclohexylmethyl
3′,4′-epoxycyclohexanecarboxylate.

| i | N | 1st order group | C |
|---|---|---|---|
| 1 | 1 | COO | 3.4637 |
| 2 | 7 | —CH2 | −0.3045 |
| 3 | 6 | —CH< | 0.6491 |
| 4 | 2 | O | 3.3432 |
| j | M | 2nd order group | D |
| 1 | 2 | C6 ring | −3.6437 |

Total: 11.9806 MPa^{0.5}

TABLE 2
Calculation of the polar fraction of the Hansen solubility
parameters δₚ for 2-hydroxy-3-phenoxypropyl acrylate.

| i | N | 1st order group | C |
|---|---|---|---|
| 1 | 5 | ACH | −0.5303 |
| 2 | 1 | AC | 0.6187 |
| 3 | 1 | CH2O | 0.8826 |
| 4 | 1 | —CH< | 0.6491 |
| 5 | 1 | OH | 1.1404 |
| 6 | 1 | —CH2 | −0.3045 |
| 7 | 1 | COO | 3.4637 |
| 8 | 1 | CH2═CH— | −2.0035 |
| j | M | 2nd order group | D |
| 1 | 1 | AC—O—C | 0.8153 |

Total: 9.9651 MPa^{0.5}

The skilled person understands that the calculation of the Hansen solubility parameters within the scope of the present invention for the polymerizable compounds Y can be performed directly on the monomers, but that the polarity of the A and B blocks is effected via the evaluation of the monomer units, i.e. the repeating units in the polymer chain, so that a CH₂═CH— group is considered as the —CH₂—CH— group compared to the monomers used for the production, i.e. the A monomers and the B monomers.

According to the specifications of the calculation method, when mixtures of polymerizable compounds Y or mixtures of A monomers or B monomers are used in the production of copolymers, an average value of the polar fraction of the Hansen solubility parameters is formed, wherein the contributions of the individual monomers are weighted via their amount-of-substance fraction, and so, in the context of the present invention, the polar fractions, weighted for amount of substance, of the Hansen solubility parameters <δₚ> are considered, which are calculated according to the group contribution method of Stefanis and Panayiotou as explained above.

Table 3 shows the polar fractions of the Hansen solubility parameters illustratively for selected monomers, which are highly relevant in the field of the curable adhesive compounds as basic building blocks for polymers.

TABLE 3
Polar fractions of the Hansen solubility parameters
δₚ for illustrative monomers (rounded).

| | δₚ/ |
|---|---|
| Monomer | MPa^{0.5} |
| n-Butyl acrylate | 8.60 |
| 2-Ethylhexyl acrylate | 7.00 |
| Heptadecyl acrylate | 1.55 |
| Ethyl acrylate | 9.21 |
| Ethylene diglycol acrylate | 10.37 |
| Hydroxyethyl acrylate | 12.00 |
| Lauryl acrylate | 2.54 |
| Methoxyethyl acrylate | 10.73 |
| Methyl acrylate | 9.52 |
| 2-Phenoxyethyl acrylate | 6.20 |
| 2-Phenoxydiethylene glycol acrylate | 9.36 |
| Propylheptyl acrylate | 6.39 |
| Stearyl acrylate | 1.70 |
| n-Octyl acrylate | 7.40 |
| Acrylic acid | 8.60 |
| Dihydrodicyclopentadienyl acrylate | 4.60 |
| Isobornyl acrylate | 6.10 |
| t-Butyl acrylate | 9.50 |
| Methyl methacrylate | 9.31 |

It can be seen as an advantage of the curable adhesive compounds of the invention that they are very flexible with regard to the mechanism used for curing. The skilled person selects the mechanism necessary for curing essentially in the light of the application requirements and adapts the curable adhesive compound of the invention accordingly to their own requirements. This is done in accordance with the sector standard procedure by selecting the appropriate reactive resin and, where necessary, selecting the initiators and/or coinitiators required for it. For most applications, it will be useful in practice if the curable adhesive compound of the invention additionally comprises one or more initiators. With regard to the later handling properties, it is particularly advantageous according to the inventors' assessment to use radiation-crosslinking and/or thermally crosslinking systems, wherein in particular the radiation activation provides great handling advantages. Preferred is a curable adhesive compound of the invention, wherein the curable adhesive compound is a radiation-curing and/or thermally curing adhesive compound, and/or wherein the curable adhesive compound is curable by polymerization of the polymerizable compounds Y, preferably by radiation activation and/or thermal activation. Preferred accordingly is a curable adhesive compound of the invention, wherein the curable adhesive compound comprises one or more initiators, preferably in a combined mass fraction in the range from 0.05% to 4%, preferably in the range from 0.1% to 3%, based on the mass of the adhesive compound, and/or wherein the one or more initiators are preferably selected from the group consisting of radiation-activated initiators and thermally activated initiators and/or are selected from the group consisting of initiators for radical polymerization and initiators for cationic polymerization, for example triarylsulfonium hexafluoroantimonate or diisopropylbenzene hydroperoxide in combination with Ru(bipy)₃ Cl₂ hexahydrate.

As explained above, the initiators used are adapted by the skilled person to the polymerizable compounds Y used in each case.

If the polymerizable compounds Y are a radically polymerizable compound (e.g. a (meth)acrylate), light curing or thermal curing can be used, for example. For example, type I or type II photoinitiators are suitable for light curing, as described, for example, in “Industrial Photoinitiators: A Technical Guide” 2010 by W. A. Green. Typically, the mass fraction of these photoinitiators in the curable adhesive compound is not more than 3% but at least 0.1%, and is preferably in the range from 0.5% to 2%. Photoredox catalysts can also be used here, in particular for non-transparent substrates, as is disclosed, for example, in DE 102019209513 A1. For thermal curing, for example, the polymerization initiators described above are suitable, with the mass fraction of these polymerization initiators being not more than 3% but at least 0.1% and preferably in the range from 0.5% to 2%.

Even if the polymerizable compounds Y are a cyclic ether compound (e.g. an epoxide), light curing or thermal curing can be used, for example. For thermal curing, so-called hardeners and accelerators are usually used in this case. The hardener causes the chemical crosslinking, with the accelerators in the presence of a hardener increasing the reaction rate of the curing reaction and/or the rate of activation of the curing of the epoxy resins. The lists of substances that can be used as hardeners or accelerators overlap, and the individual representatives can also simultaneously realize both modes of operation, so that the transition between hardener and accelerator is usually fluid, without the selection of a suitable system of hardener and accelerator posing major challenges for the skilled person. For example, compounds selected from the group consisting of dicyandiamides, imidazoles, anhydrides, epoxy-amine adducts, hydrazides and reaction products of diacids and multifunctional amines can be used as hardeners and/or accelerators. Examples of useful reaction products of diacids and polyfunctional amines include reaction products of phthalic acid and diethylenetriamine. Stoichiometric hardeners such as dicyandiamide are preferably used based on the epoxy amount of the adhesive compound. Non-stoichiometric hardeners such as imidazoles and epoxy-amine adducts are typically used in fractions of up to 20% based on the epoxy fraction.

Sulfonium, iodonium and metallocene based systems in particular can be used as initiators for a cationic UV-induced curing of cyclic ether compounds. For examples of sulfonium based cations, refer to the observations in U.S. Pat. No. 6,908,722 B1. Examples of anions which serve as counterions for the abovementioned cations include tetrafluoroborate, tetraphenylborate, hexafluorophosphate, perchlorate, tetrachloroferrate, hexafluoroarsenate, hexafluoroantimonate, pentafluorohydroxyantimonate, hexachloroantimonate, tetrakispentafluorophenylborate, tetrakis(pentafluoromethylphenyl) borate, bi (trifluoromethylsulfonyl)amide and tris(trifluoromethylsulfonyl) methide. Other conceivable anions particularly for iodonium-based initiators are additionally chloride, bromide or iodide, but preference is given to initiators that are essentially free of chlorine and bromine. A powerful example of such a system is, for example, triphenylsulfonium hexafluoroantimonate. Other initiators are disclosed for example in U.S. Pat. Nos. 3,729,313 A, 3,741,769 A, 4,250,053 A, 4,394,403 A, 4,231,951 A, 4,256,828 A, 4,058,401 A, 4,138,255 A and US 2010/063221 A1. Photoinitiators are typically used individually or as a combination of two or more photoinitiators. When using photoinitiators, combinations with so-called sensitizers for the adaptation of the activation wavelength of the photoinitiation system to the selected emission spectrum are very helpful; in this regard, refer to the literature known to the skilled person, such as “Industrial Photoinitiators: A Technical Guide” 2010 by A. W. Green. Typically, in these cases, the mass fraction of photoinitiators in the curable adhesive compound is not more than 4% but at least 0.1%, and is preferably in the range from 0.5% to 2%. The mass fraction of sensitizers is usually not more than 3% and is preferably in the range from 0.5% to 2%.

For later use in the end application, it is advantageous for the handling properties if the curable adhesive compound has an intrinsic pressure-sensitive adhesiveness and can thus be classified as a pressure-sensitive adhesive. Owing to the advantageously high cohesion in curable adhesive compounds of the invention, it is particularly easy to adjust these properties in curable adhesive compounds of the invention. The pressure-sensitive adhesiveness allows reliable and secure application of the reactive adhesive tapes to the substrate before the curing of the curable adhesive compounds. Preferable therefore is a curable adhesive compound of the invention, wherein the curable adhesive compound is a pressure-sensitive adhesive.

A pressure-sensitive adhesive, in accordance with the skilled understanding, is an adhesive compound which has pressure-sensitive adhesive properties, i.e. the property of making a permanent connection to an adhesion base even under relatively low contact pressure. Corresponding pressure-sensitive adhesive tapes are usually redetachable from the adhesion base after use, essentially free of residue, and are usually permanently self-adhesive even at room temperature, which means that they have a certain viscosity and touch-stickiness, so that they wet the surface of a substrate even with little contact pressure. The pressure-sensitive adhesiveness of a pressure-sensitive adhesive tape results from the fact that a pressure-sensitive adhesive is used as the adhesive compound. Without wanting to be bound by this theory, it is often assumed that a pressure-sensitive adhesive can be considered as an extremely high-viscosity fluid with an elastic component, which consequently has characteristic viscoelastic properties, which lead to the above-described permanent self-adhesiveness and pressure-sensitive adhesive capacity. It is assumed that with corresponding pressure-sensitive adhesives, mechanical deformation results both in viscous flow processes and in the build-up of elastic restoring forces. The proportional viscous flow is used to achieve adhesion, while the proportional elastic restoring forces are necessary particularly for achieving cohesion. The relationships between rheology and pressure-sensitive adhesiveness are known in the prior art and are described, for example, in “Satas, Handbook of Pressure Sensitive Adhesive Technology”, Third Edition (1999), pages 153 to 203. The storage modulus (G′) and the loss modulus (G″), which can be determined by means of dynamic mechanical analysis (DMA), for example using a rheometer, as disclosed, for example, in WO 2015/189323, are usually used to characterize the extent of elastic and viscous components. In the context of the present invention, an adhesive is preferably understood as being pressure-sensitively adhesive and thus as a pressure-sensitive adhesive when at a temperature of 23° C. in the deformation frequency range from 10⁰ to 10¹ rad/sec, G′ and G″ are each at least in part in the range from 10³ to 10⁷ Pa.

Basically, it is conceivable that low molecular mass oligomers can also be used as polymerizable compounds Y, which are then crosslinked with each other during the curing of the curable adhesive compounds. However, for the vast majority of cases, it is particularly preferred, in view of the reactive resins used in practice, if the polymerizable compounds Y are polymerizable Y monomers, in particular because the processing properties of such Y monomers can in many cases be adjusted more favourably and more accurately than with oligomers. Preferred, therefore, is a curable adhesive compound of the invention, wherein the polymerizable compounds Y are selected from the group consisting of polymerizable Y monomers.

According to the inventors' assessment, particularly powerful curable adhesive compounds can be obtained more particularly with cyclic ethers, especially epoxy monomers, and acrylate monomers as reactive resins. In particular, for corresponding monomers, particularly favourable polar fractions of the Hansen solubility parameters regularly result which are neither too high nor too low, so that sufficient flexibility remains in the adjusting of the A and B blocks. Preferred is a curable adhesive compound of the invention, wherein the polymerizable compounds Y are selected from the group consisting of oxetane compounds, in particular oxetane monomers, epoxy compounds, in particular epoxy monomers, and (meth)acrylate monomers, preferably epoxy monomers and acrylate monomers.

According to the inventors' assessment, it makes sense when adjusting the required polarity differences, because of the usually quite different polarities of typical oxetane, epoxy and acrylate monomers, to use predominantly, preferably completely, only one class of these polymerizable compounds Y as a reactive resin, with the inventors having succeeded in identifying polymerizable compounds that are particularly powerful in this respect.

In principle, suitable reactive monomers are, for example, acrylic acid esters (such as 2-ethylhexyl acrylate), methacrylic acid esters, vinyl compounds and oligomeric or polymeric compounds with carbon-carbon double bonds, and also (meth)acrylates of higher functionality. Preferred monomers with regard to a high bond strength are (meth)acrylic acid esters in which the alcohol part of the ester contains aromatic structural elements, heteroatoms or functional groups. Preferred are urethane groups, urea groups, oxygen or nitrogen heterocycles, ether groups, ester groups, acid functions and/or hydroxyl functions. With regard to good wet heat resistance, (meth)acrylic acid esters in which the alcohol part of the ester is a fatty alcohol are also preferred. Furthermore, crosslinking monomers are preferred with regard to a high crosslinking density. Examples of preferred monomers are 2-phenoxyethyl acrylate (CAS No.: 48145-04-6), 2-phenoxyethyl methacrylate (CAS No.: 10595-06-9), 2-hydroxy-3-phenoxypropyl acrylate (CAS No.: 16969-10-1), 2-hydroxy-3-phenoxypropyl methacrylate (CAS No.: 16926-87-7), 2-[2-(methacryloyloxy) ethoxycarbonyl]benzoic acid (CAS No.: 27697-00-3), 2-[[(phenylamino) carbonyl]oxy]ethyl methacrylate (CAS No.: 51727-47-0), 2-tert-butyl-6-[(3-tert-butyl-2-hydroxy-5-methylphenyl)methyl]-4-methylphenyl prop-2-enoate (CAS No.: 61167-58-6), 5-ethyl-1,3-dioxan-5-yl methylacrylate (CAS No. 66492-1.3-1), (2-oxo-1,3-dioxolan-4-yl)methyl methacrylate (CAS No.: 13818-44-5), di(ethylene glycol) 2-ethylhexyl ether acrylate (CAS No.: 117646-83-0), (2,2-dimethyl-1,3-dioxolan-4-yl)methyl prop-2-enoate (CAS No.: 13188-82-4), succinic acid mono [2-(acryloyloxy)ethyl ester] (CAS No.: 50940-49-3), succinic acid mono [2-(methacryloyloxy)ethyl ester] (CAS No.: 20882-04-6), (2,2-pentamethylene-1,3-oxazolid-3-yl)ethyl methacrylate (CAS No.: 4203-89-8, 2-hydroxy-3-(prop-2-enoyloxy) propyl 2-methyl-2-propylhexanoate (CAS No.: 444649-70-1), 2-[[(butylamino) carbonyl]oxy]ethyl acrylate (CAS No.: 63225-53-6), stearyl acrylate (CAS No.: 4813-57-4), stearyl methacrylate (CAS No.: 32360-05-7), and the crosslinking reactive monomers diurethane dimethacrylate (isomer mixture) (CAS No.: 72869-86-4), bisphenol A glycerolate dimethacrylate (BIS-GMA, CAS No.: 1565-94-2, e.g. Ebecryl 600), bisphenol A dimethacrylate (BIS-DMA, CAS No.: 3253-39-2), ethylene glycol diacrylate (CAS No.: 2274 Nov. 5), ethylene glycol dimethacrylate (CAS No.: 97-90-5), trimethyloylpropane propoxylate triacrylate (CAS No.: 53879-54-2), trimethyloylpropane triacrylate (CAS No.: 15625-89-5) and/or di(trimethylolpropane)tetraacrylate (CAS No.: 94108-97-1). Particularly preferred are 2-hydroxy-3-phenoxypropyl acrylate, 2-[(butylamino)carbonyl]oxy]ethyl acrylate and diurethane dimethacrylate.

Fundamentally preferred is thus a curable adhesive compound of the invention, wherein the polymerizable compounds Y are selected from the group consisting of (meth)acrylate monomers, preferably acrylate monomers, particularly preferably aromatic acrylate monomers, very preferably 2-hydroxy-3-phenoxypropyl acrylate, 2-[[(butylamino) carbonyl]oxy]ethyl acrylate and diurethane dimethacrylate.

Polymerizable compounds Y based on cyclic ethers are, in particular, epoxides, i.e. compounds that carry at least one oxirane group, or oxetanes. They may be aromatic or especially aliphatic or cycloaliphatic in nature. As polymerizable compounds Y, epoxy-containing materials or epoxy resins can be used, these being any organic compounds with at least one oxirane ring which are polymerizable by a ring opening reaction. Such materials include both monomeric and polymeric epoxides and may be aliphatic, cycloaliphatic or aromatic. These materials often have on average at least two epoxy groups per molecule, preferably more than two epoxy groups per molecule.

The polymeric epoxides mostly comprise linear polymers with terminal epoxy groups (e.g. a diglycidyl ether of a polyoxyalkylene glycol), polymers with framework oxirane units (e.g. polybutadiene polyepoxide) and polymers with epoxy side groups (e.g. a glycidyl methacrylate polymer or copolymer). The molecular weight of such epoxy compounds may vary from 58 to about 100 000 g/mol or more. Examples of epoxy-containing polymerizable compounds Y include, for example, epoxycyclohexanecarboxylates, such as, for example, 4-epoxyclohexylmethyl 3,4-epoxycyclohexanecarboxylate, 3,4-epoxy-2-methylcyclohexylmethyl 3,4-epoxy-2-methylcyclohexanecarboxylate, and bis(3,4-epoxy-6-methylcyclohexylmethyl) adipate. Further examples of epoxy-containing polymerizable compounds Y are disclosed in, for example, U.S. Pat. No. 3,117,099 A. Other epoxy-containing polymerizable compounds Y which are particularly useful in the application of this invention include glycidyl ether monomers, as disclosed for example in U.S. Pat. No. 3,018,262. Examples are the glycidyl ethers of polyhydric phenols obtained by reacting a polyhydric phenol with an excess of chlorohydrin, such as epichlorohydrin (e.g. the diglycidyl ether of 2,2-bis(2,3-epoxypropoxyphenol) propane). In particular, diglycidyl ethers of bisphenols, such as bisphenol A (4,4′-(propane-2,2-diyl)diphenol). Such reaction products are commercially available in different molecular weights (type 1 to type 10 resins). Typical examples of liquid bisphenol A diglycidyl ethers are Epikote 828, D.E.R.331 and Epon 828. Typical solid BADGE resins are Araldite GT6071, GT7072, Epon 1001 and D.E.R. 662. Other reaction products of phenols with epichlorohydrin are the phenol and cresol novolac resins such as the Epiclon grades or Araldite EPN and ECN grades (e.g. ECN1273).

Preferred accordingly is a curable adhesive compound of the invention, wherein the polymerizable compounds Y are selected from the group consisting of epoxy compounds, more particularly epoxy monomers, preferably epoxy monomers comprising at least one cycloaliphatic epoxy group, particularly preferably 3,4-epoxycyclohexylmethyl 3′,4′-epoxycyclohexanecarboxylate.

A curable adhesive compound of the invention is preferred in this respect, wherein the curable adhesive compound comprises, as polymerizable compound Y, one or more epoxy compounds, more particularly epoxy resins, wherein at least one of the epoxy compounds is a solid; in particular, a solid having a softening temperature of at least 45° C., or a highly viscous substance, preferably having a dynamic viscosity at 25° C. of 50 Pa s or more, particularly preferably 100 Pa s or more, in particular preferably 150 Pa s or more (measured according to DIN 53019-1; 25° C., shear rate 1 s⁻¹).

Particularly preferred is a curable adhesive compound of the invention, wherein the curable adhesive compound comprises, as polymerizable compound Y, two or more epoxy compounds, more particularly epoxy resins, wherein at least one epoxy compound at 25° C. is a liquid with a dynamic viscosity of 40 Pa s or less, preferably 20 Pa s or less, and at least one epoxy compound at 25° C. is a solid or a highly viscous substance with a dynamic viscosity of 50 Pa s or more. The combined mass fraction of the liquid epoxy compounds for which the dynamic viscosity at 25° C. is 40 Pa s or less among the polymerizable compounds Y is in particular 10% to 90%, preferably 20% to 75%, particularly preferably more than 50%, very preferably more than 70%. The respective difference to 100% by weight of the epoxy resins is then made up by solid or highly viscous epoxy resins. Curable adhesive compounds with such ratios of liquid and solid or highly viscous epoxy components exhibit particularly balanced adhesive properties in the uncured state. If an adhesive tape with particularly good flow-on properties is desired, the combined mass fraction of liquid epoxy compounds whose dynamic viscosity at 25° C. is 40 Pas or less is preferably in the range of 50% to 80%. For applications in which the adhesive tapes have to bear a relatively high load even in the uncured state, a combined mass fraction of 15% to 45% is particularly preferred.

It can be seen as an advantage of the curable adhesive compounds of the invention that even with large mass fractions of liquid polymerizable compounds Y, a high cohesion and sufficient diecuttability can be achieved. Accordingly, it is particularly preferred if such liquid reactive resins are also used in the curable adhesive compound, which is also particularly preferable with regard to the flow-on behaviour to be achieved. It is therefore preferable to use a curable adhesive compound of the invention, wherein at least one, preferably all, of the polymerizable compounds Y at 25° C. are liquid, preferably with a dynamic viscosity of 40 Pa s or less, particularly preferably 20 Pa s or less; very preferably 10 Pa s or less. A curable adhesive compound of the invention is very particularly preferred, wherein the combined mass fraction of polymerizable compounds Y liquid at 25° C. is 15% or more, preferably 25% or more, particularly preferably 35% or more, very preferably 45% or more.

As explained above, a particularly advantageous feature of the curable adhesive compounds of the invention is that even with large mass fractions of reactive resins, which are in principle particularly desirable with regard to the subsequent flow-on behaviour and also the peel adhesion to be realized, curable adhesive compounds can be obtained with an excellent cohesion and processability. In light of this circumstance, particularly advantageous curable adhesive compounds also result if correspondingly large mass fractions of the polymerizable compound Y are provided, since the advantages in this case are particularly clear. Accordingly, a curable adhesive compound of the invention is preferred, wherein the combined mass fraction of the polymerizable compounds Y in the curable adhesive compound is 30% or more, preferably 40% or more, and/or wherein the combined mass fraction of the polymerizable compounds Y in the curable adhesive compound is in the range from 20% to 80%, preferably in the range from 30% to 75%, particularly preferably in the range from 40% to 70%.

Even if it is possible in principle to produce the A and/or B blocks at least partially from methacrylate monomers, according to the inventors' assessment the use of acrylate monomers is particularly preferred, especially since their processing properties regularly favour the production of high-performance curable adhesive compounds. For all embodiments, therefore, a curable adhesive compound of the invention is preferred, wherein the one or more (meth)acrylate block copolymers X are acrylate block copolymers, where the A blocks and the B block are acrylate polymers.

According to the inventors' assessment, it is an advantage of the curable adhesive compounds of the invention that the favourable cohesion properties result even at comparatively low mass fractions of the (meth)acrylate block copolymers. In this respect, however, the experiments of the inventors show that it is advantageous, especially with regard to the realizable peel adhesion, to increase the mass fraction of this component. A curable adhesive compound of the invention is preferred, wherein the combined mass fraction of the (meth)acrylate block copolymers X in the curable adhesive compound is 25% or more, preferably 30% or more, and/or wherein the combined mass fraction of the (meth)acrylate block copolymers X in the curable adhesive compound is in the range from 20% to 70%, preferably in the range from 25% to 65%, particularly preferably in the range from 30% to 55%.

In this respect, the inventors have in particular succeeded in identifying suitable ratios of the components X and Y. A curable adhesive compound of the invention is preferred, indeed, wherein the ratio of the combined amounts of substance of the (meth)acrylate block copolymers X to the combined amount of substance of the polymerizable compounds Y is in the range from 3:1 to 1:3, preferably in the range from 2:1 to 1:2, particularly preferably in the range from 1.5:1 to 1:1.5.

According to the inventors' assessment, the focus in distinguishing the A and B blocks within the scope of the present invention is primarily on the different polarities, which are evaluated as described above. Nevertheless, the glass transition temperature also has a supplementary significance, and based on the inventors' findings, the limit as defined above can be seen at 50° C. According to the inventors' assessment, however, it is advantageous for the physico-chemical properties to be achieved in the curable adhesive compound if hard blocks with a comparatively high glass transition temperature are used as A blocks and B blocks with a relatively low glass transition temperature are used correspondingly as soft blocks. A curable adhesive compound of the invention is preferred, wherein the A blocks independently of each other are a poly(meth)acrylate having a glass transition temperature Tg of more than 60° C., preferably more than 70° C., more preferably more than 80° C., and/or wherein the B block is a poly(meth)acrylate having a glass transition temperature Tg of less than 40° C., preferably less than 30° C., more preferably less than 20° C.

As explained above, it is not automatically necessary, and also not to be expected in the light of the typical variance in the production of polymers, that the A blocks in each (meth)acrylate block copolymer are identical, so that the above definition ultimately defines only a minimum or maximum glass transition temperature and the chemical nature of the monomeric units in the respective (co) polymers. The skilled person understands, however, that particularly with regard to manufacturing aspects and with regard to the homogeneity of the physico-chemical properties of the curable adhesive compound that can be produced with them, those (meth)acrylate block copolymers are preferred in which the A blocks are as similar as possible, and it is considered particularly advantageous if the A blocks are produced in such a way that that they are substantially identical within the typical variance in polymer chemistry, or show a low polydispersity. In accordance with the skilled understanding, particularly powerful (meth)acrylate block copolymers result if the A blocks are produced from the same A monomer composition under identical polymerization conditions. A curable adhesive compound of the invention is preferred in this context, wherein the two A blocks are poly(meth)acrylates for which the glass transition temperature differs by less than 5° C., preferably by less than 3° C., particularly preferably by less than 1° C., wherein the poly(meth)acrylates can be produced by polymerization of the same A monomer composition of A monomers, with the A blocks being preferably substantially identical.

Even if the use of copolymers in the A and B blocks is conceivable in principle, potentially also with at least small fractions of monomers which are not (meth)acrylate-based monomers, the inventors estimate that it is preferred for the vast majority of cases if the A or B blocks are (meth)acrylate-based as much as possible and in this respect consist exceptionally preferably substantially of one type of acrylate-based monomers. It is therefore preferable to use a curable adhesive compound of the invention, wherein the A monomers comprise one or more monomers, preferably one monomer, which are selected from the group consisting of (meth)acrylate monomers and (meth)acrylic acid, preferably acrylate monomers and acrylic acid, particularly preferably acrylate monomers, wherein the A monomers consist to an extent preferably of 90% or more, particularly preferably 95% or more, very preferably 99% or more, exceptionally preferably substantially completely, of these monomers, based on the combined mass of the A monomers. Preferred likewise is a curable adhesive compound of the invention, wherein the B monomers comprise one or more monomers, preferably one monomer, which are selected from the group consisting of (meth)acrylate monomers and (meth)acrylic acid, preferably acrylate monomers and acrylic acid, particularly preferably acrylate monomers, wherein the B monomers consist to an extent preferably of 90% or more, particularly preferably 95% or more, very preferably 99% or more, exceptionally preferably substantially completely, of these monomers, based on the combined mass of the B monomers. In this respect, it is particularly preferred if the above features for the A monomers and B monomers are set in the same manner, wherein in particular it is preferred if the respective monomers are each substantially completely formed of a corresponding monomer of the specified types. The corresponding (meth)acrylate block copolymers do not only result in excellent cohesion in the curable adhesive compounds, but in particular are also particularly easy, reliable and reproducible to produce, so that warehousing cost and complexity can be reduced in particular and the setting of a consistent product quality is facilitated.

On the basis of the observations above, the inventors have succeeded in identifying particularly suitable monomers for the A monomers and the B monomers and thus for the chemical nature of the A and B blocks, which, in the inventors' estimation, result in particularly high-performance curable adhesive compounds of the invention, with the above observations applying correspondingly to the formation of the A and B blocks as largely pure polymers. The A monomers described below as preferred are therefore particularly favourable, since they have the required distance in the polar fraction of the Hansen solubility parameters with respect to a wide range of reactive resins commonly used, in particular to typical epoxy monomers with at least one cycloaliphatic epoxy group and also aromatic acrylate monomers. In the same way, the B monomers described below as preferred are particularly favourable, since their polarity for the two preferred classes of reactive resins is within the defined range.

A curable adhesive compound of the invention is preferred, indeed, wherein the A monomers comprise one or more monomers, preferably one monomer, which are selected from the group consisting of n-octyl acrylate, 2-ethyhexyl acrylate, propylheptyl acrylate, 2-phenoxyethyl acrylate, isobornyl acrylate, dihydrodicyclopentadienyl acrylate, lauryl acrylate, stearyl acrylate and heptadecyl acrylate, preferably propylheptyl acrylate, 2-phenoxyethyl acrylate, isobornyl acrylate, dihydrodicyclopentadienyl acrylate, lauryl acrylate, stearyl acrylate and heptadecyl acrylate, particularly preferably of phenoxyethyl acrylate, isobornyl acrylate and dihydrodicyclopentadienyl acrylate, wherein the A monomers consist to an extent preferably of 90% or more, particularly preferably 95% or more, very preferably 99% or more, exceptionally preferably substantially completely, of these monomers, based on the combined mass of the A monomers. A curable adhesive compound of the invention is also preferred, wherein the B monomers comprise one or more monomers, preferably one monomer, which are selected from the group consisting of n-octyl acrylate, 2-ethyhexyl acrylate, hydroxyethyl acrylate, methoxyethyl acrylate, ethylene diglycol acrylate, 2-phenoxydiethylene glycol acrylate, methyl acrylate, ethyl acrylate, tert-butyl acrylate, n-butyl acrylate, methyl methacrylate and acrylic acid, preferably from hydroxyethyl acrylate, methoxyethyl acrylate, ethylene diglycol acrylate, 2-phenoxydiethylene glycol acrylate, methyl acrylate, ethyl acrylate, tert-butyl acrylate, n-butyl acrylate, methyl methacrylate and acrylic acid, particularly preferably n-butyl acrylate, ethyl acrylate and acrylic acid, wherein the B monomers consist to an extent preferably of 90% or more, particularly preferably 95% or more, very preferably 99% or more, exceptionally preferably substantially completely, of these monomers, based on the combined mass of the B monomers. The overlap in the monomers n-octyl acrylate and 2-ethylhexyl acrylate listed here therefore results in these monomers being particularly suitable for A or B blocks depending on the reactive resin used.

The number-average molecular weights Mₙ of the (meth)acrylate block copolymers X are preferably in a range from 20 000 to 2 000 000 g/mol, particularly preferably in a range from 100 000 to 1 500 000 g/mol, very preferably in a range from 150 000 to 1 000 000 g/mol. The data for the number-average molar mass Mₙ refers to the determination by gel permeation chromatography (GPC). The determination is carried out using a clear filtered 100 μl sample (sample concentration 4 g/l). The eluent employed is THF comprising 0.1 vol % trifluoroacetic acid. The measurement is conducted at 25° C. The pre-column used is a column type PSS-SDV, 5 μm, 10³ Å, 8.0 mm*50 mm (values here and below in the sequence: type, particle size, porosity, internal diameter*length; 1 Å=10⁻¹⁰ m). For the separation, a combination is used of the columns of the type PSS-SDV, 5 μm, 10³ Å and also 10⁵ Å and 10⁶ Å, in each case 8.0 mm*300 mm (columns from Polymer Standards Service; detection by means of differential refractometer Shodex RI71). The flow rate is 1.0 ml per minute. The calibration is carried out for polyacrylates against PMMA standards (polymethyl methacrylate calibration) and otherwise (resins, elastomers) against PS standards (polystyrene calibration).

Although the above-defined limit of 3.5 MPa^{0.5} is, according to the inventors' knowledge, the useful dividing line for distinguishing suitable A and B blocks, the inventors consider it particularly advantageous to select the polarity difference as large as possible for the A blocks and to aim with the B blocks for a polarity which is as close as possible to those of the polarizable Y compounds. Therefore, a curable adhesive compound of the invention is preferred, wherein the polar fractions, weighted for amount of substance, of the Hansen solubility parameters <δₚ> are subject to |<δₚ>(A)−<δₚ>(Y)|>3.8 MPa^{0.5}, preferably |<δₚ>(A)−<δₚ>(Y)|>4.5 MPa^{0.5}, particularly preferably |<δₚ>(A)−<δₚ>(Y)|>5.2 MPa^{0.5}, and/or the polar fractions, weighted for amount of substance, of the Hansen solubility parameters <δₚ> are subject to |<δₚ>(B)−<δₚ>(Y)|<3.4 MPa^{0.5}, preferably |<δₚ>(B)−<δₚ>(Y)|<2.8 MPa^{0.5}, particularly preferably |<δₚ>(B)−<δₚ>(Y)|<2.2 MPa^{0.5.}

In developing the invention, the inventors have succeeded in identifying suitable ranges for the absolute polar fractions of the Hansen solubility parameter of the A monomers and the B monomers and also of the polymerizable compounds Y, with which particularly high-performance curable adhesive compounds can be realized. In the inventors' estimation, the range specifications identified in this respect are particularly helpful in designing new (meth)acrylate block copolymers for the respective applications quickly and reliably, since the corresponding polar fractions of the Hansen solubility parameters can be looked up, for example from tabulated values, against the background of this disclosure. A curable adhesive compound of the invention is preferred, indeed, wherein the polar fraction, weighted for amount of substance, of the Hansen solubility parameter of the monomer units derived from A monomers in the A blocks <δₚ>(A) is in the range from 0.5 to 7.5 MPa^{0.5}, preferably in the range from 1.0 to 7.0 MPa^{0.5}, particularly preferably in the range from 1.5 to 6.5 MPa^{0.5}, and/or wherein the polar fraction, weighted for amount of substance, of the Hansen solubility parameter of the monomer units derived from B monomers in the B block <δₚ>(B) is in the range from 8.0 to 13.0 MPa^{0.5}, preferably in the range from 8.5 to 12.0 MPa^{0.5}, particularly preferably in the range from 9.0 to 11.0 MPa^{0.5}, and/or wherein the polar fraction, weighted for amount of substance, of the Hansen solubility parameter of the polymerizable compounds Y in the curable adhesive compound <δₚ>(Y) is in the range from 8.5 to 13.0 MPa^{0.5}, preferably in the range from 9.0 to 12.5 MPa^{0.5}, particularly preferably in the range from 9.5 to 12.0 MPa^{0.5.}

Finally, it can be seen as an advantage of curable adhesive compounds of the invention that they are very flexible with regard to the use of typical additives, so that the physico-chemical properties can be further adapted specifically to the requirements of the respective end application. Preferred, therefore, is a curable adhesive compound, wherein the curable adhesive compound comprises one or more further additives, preferably in a combined mass fraction in the range from 0.1% to 50%, preferably 0.2% to 40%, based on the mass of the adhesive compound, and/or wherein the one or more further additives are preferably selected from the group consisting of tackifier resins, ageing inhibitors, light stabilizers, UV absorbers and rheological additives.

A special case of the further components which are used to adjust the properties of adhesive compounds are insoluble fillers, which can be added to the curable adhesive compound in order to obtain a filled curable adhesive compound. These are particulate fillers with an average particle diameter (D50) of 5 μm or more, preferably 10 μm or more, especially preferably 20 μm or more, which are not soluble in the curable adhesive compound and are therefore present therein as a dispersion, and also macroscopic fillers such as fibres, for example. Preferably, the insoluble fillers are selected from the group consisting of particulate fillers. Particularly preferably, the insoluble fillers are selected from the group consisting of expandable hollow polymer spheres, non-expandable hollow polymer spheres, solid polymer spheres, hollow glass spheres, solid glass spheres, hollow ceramic spheres, solid ceramic spheres and/or solid carbon spheres. However, suitable insoluble fillers also include fibres, laid scrims, platelets and rodlets composed of materials insoluble in the curable adhesive compound. Owing to their in some cases already macroscopic dimensions and the lack of solubility, these essentially have no influence on the above-disclosed relationships of the compositional chemistry of the curable adhesive compounds, but rather are present in heterogeneous mixture with the curable adhesive compound. Accordingly, these insoluble fillers are not attributed to the curable adhesive compound within the scope of the present invention and are accordingly not taken into account in the calculation of mass fractions relative to the mass of the curable adhesive compound. As described above, the present invention instead defines that the addition of insoluble fillers to a curable adhesive compound of the invention results in a filled curable adhesive compound, i.e. a filled curable adhesive compound comprising:
x) a curable adhesive compound of the invention, preferably as disclosed above as preferred, and
y) one or more insoluble fillers.

Particularly preferably, the combined mass fraction of the insoluble fillers here is in the range from 1% to 50%, preferably in the range from 2% to 40%, particularly preferably in the range from 5% to 30%, based on the mass of the filled curable adhesive compound.

Below, illustrative curable adhesive compounds are disclosed which in the estimation of the inventors are particularly advantageous and which describe particularly preferred combinations of features, particular preference being given to curable adhesive compounds of the invention comprising two or more of the illustrative curable adhesive compounds.

Preferred, firstly, is a first, thermally curable adhesive compound of the invention, based on radically curing polymerizable compounds Y, comprising, based on the mass of the adhesive compound: i) a corresponding (meth)acrylate block copolymer X1 of structure A-B-A in a mass fraction in the range from 30% to 55%, ii) a liquid acrylate monomer, for example phenoxyethyl acrylate, in a mass fraction in the range from 20% to 35%, iii) a highly viscous acrylate oligomer, for example Ebecryl 600 (viscosity at 25° C. of more than 150 Pa s), in a mass fraction in the range from 20% to 35%, and iv) a thermal radical initiator, for example benzopinacol, in a mass fraction in the range from 0.5% to 5%.

Also preferred is a second, UV-curable adhesive compound of the invention, based on radically curing polymerizable compounds Y, comprising, based on the mass of the adhesive compound: i) a corresponding (meth)acrylate block copolymer X1 of structure A-B-A in a mass fraction in the range from 25% to 45%, ii) a liquid acrylate monomer, for example phenoxyethyl acrylate, in a mass fraction in the range from 20% to 40%, iii) a highly viscous acrylate oligomer, for example Ebecryl 600 (viscosity at 25° C. of more than 150 Pas), in a mass fraction in the range from 20% to 40%, iv) a radical initiator, for example diisopropylbenzene hydroperoxide, in a mass fraction in the range from 0.5% to 5%, and v) a photoredox catalyst, for example (Ru(bypy)₃ Cl₂), in a mass fraction in the range from 0.01% to 2%.

Also preferred is a third, UV-curable adhesive compound of the invention, based on radically curing polymerizable compounds Y, comprising, based on the mass of the adhesive compound: i) a corresponding (meth)acrylate block copolymer X1 of structure A-B-A in a mass fraction in the range from 40% to 60%, ii) a liquid acrylate monomer, for example phenoxyethyl acrylate, in a mass fraction in the range from 10% to 35%, iii) a highly viscous acrylate oligomer, for example Ebecryl 600 (viscosity at 25° C. of more than 150 Pas), in a mass fraction in the range from 10% to 35%, iv) a radical initiator, for example diisopropylbenzene hydroperoxide, in a mass fraction in the range from 0.5% to 5%, and v) a photoredox catalyst, for example (Ru(bypy)₃ Cl₂), in a mass fraction in the range of 0.01% to 2%.

Also preferred is a fourth, UV-curable adhesive compound of the invention, based on radically curing polymerizable compounds Y, comprising, based on the mass of the adhesive compound: i) a corresponding (meth)acrylate block copolymer X1 of structure A-B-A in a mass fraction in the range from 25% to 45%, ii) a liquid acrylate monomer, for example phenoxyethyl acrylate, in a mass fraction in the range from 10% to 30%, iii) a highly viscous acrylate oligomer, for example Ebecryl 600 (viscosity at 25° C. of more than 150 Pa s), in a mass fraction in the range of 10% to 30%, iv) a filler, for example Silibeads 5211, in a mass fraction of 25%, v) a radical initiator, such as diisopropylbenzene hydroperoxide, in a mass fraction in the range from 0.5% to 5%, and vi) a photoredox catalyst, such as (Ru(bypy)₃ Cl₂), in a mass fraction in the range from 0.01% to 2%.

Also preferred is a fifth, UV-curable adhesive compound of the invention, based on radically curing polymerizable compounds Y, comprising, based on the mass of the adhesive compound: i) a corresponding (meth)acrylate block copolymer X1 of structure A-B-A in a mass fraction in the range from 25% to 45%, ii) a liquid acrylate monomer, for example phenoxyethyl acrylate, in a mass fraction in the range from 20% to 40%, iii) a polymeric additive, for example poly-N-vinylpyrrolidone, in a mass fraction in the range from 10% to 30%, iv) a radical initiator, for example diisopropylbenzene hydroperoxide, in a mass fraction in the range from 0.5% to 5%, and v) a photoredox catalyst, for example (Ru(bypy)₃ Cl₂), in a mass fraction in the range from 0.01% to 2%.

Also preferred is a sixth, thermally curable adhesive compound of the invention, based on cyclic ether compounds as polymerizable compounds Y, comprising, based on the mass of the adhesive compound: i) a corresponding (meth)acrylate block copolymer X1 of structure A-B-A in a mass fraction in the range from 30% to 45%, ii) a liquid epoxide, for example Epikote 828, in a mass fraction in the range from 20% to 35%, iii) a solid epoxide, for example Araldite ECN 1273, in a mass fraction in the range from 20% to 35%, iv) a hardener, for example dicyandiamide, in a mass fraction in the range from 2% to 6%, and v) an accelerator, for example Curezol MZ-A, in a mass fraction in the range from 0.01% to 0.5%.

Also preferred is a seventh, thermally curable adhesive compound of the invention, based on cyclic ether compounds as polymerizable compounds Y, comprising, based on the mass of the adhesive compound: i) a corresponding (meth)acrylate block copolymer X1 of structure A-B-A in a mass fraction in the range from 45% to 60%, ii) a liquid epoxide, for example Epikote 828, in a mass fraction in the range from 15% to 30%, iii) a solid epoxide, for example Araldite ECN 1273, in a mass fraction in the range from 15% to 30%, iv) a hardener, for example dicyandiamide, in a mass fraction in the range from 2% to 5%, and v) an accelerator, for example Curezol MZ-A, in a mass fraction in the range from 0.01% to 0.5%.

Also preferred is an eighth, thermally curable adhesive compound of the invention, based on cyclic ether compounds as polymerizable compounds Y, comprising, based on the mass of the adhesive compound: i) a corresponding (meth)acrylate block copolymer X1 of structure A-B-A in a mass fraction in the range from 20% to 50%, ii) a liquid epoxide, for example Epikote 828, in a mass fraction in the range from 10% to 25%, iii) a solid epoxide, for example Araldite ECN 1273, in a mass fraction in the range from 10% to 25%, iv) a hardener, for example dicyandiamide, in a mass fraction in the range from 2% to 5%, v) an accelerator, for example Curezol MZ-A, in a mass fraction in the range from 0.01% to 0.5%, and vi) a filler, for example Silibeads 5211, in a mass fraction of 30%.

Also preferred is a ninth, thermally curable adhesive compound of the invention, based on cyclic ether compounds as polymerizable compounds Y, comprising, based on the mass of the adhesive compound: i) a corresponding (meth)acrylate block copolymer X1 of structure A-B-A in a mass fraction in the range from 20% to 35%, ii) a liquid epoxide, for example Epikote 828, in a mass fraction in the range from 0% to 25%, iii) a solid epoxide, for example Araldite ECN 1273, in a mass fraction in the range from 10% to 40%, iv) a highly viscous epoxide, for example Struktol PD3611 (viscosity at 25° C. of more than 150 Pa s), in a mass fraction in the range from 10% to 40%, v) a hardener, for example dicyandiamide, in a mass fraction in the range from 2% to 7%, and vi) an accelerator, for example Curezol MZ-A, in a mass fraction in the range from 0.01% to 0.7%.

Also preferred is a tenth, thermally curable adhesive compound of the invention, based on cyclic ether compounds as polymerizable compounds Y, comprising, based on the mass of the adhesive compound: i) a corresponding (meth)acrylate block copolymer X1 of structure A-B-A in a mass fraction in the range from 20% to 35%, ii) a solid epoxide, for example Araldite ECN 1273, in a mass fraction in the range from 10% to 60%, iii) a highly viscous epoxide, for example Struktol PD3611 (viscosity at 25° C. of more than 150 Pas), in a mass fraction in the range from 10% to 60%, iv) a hardener, for example dicyandiamide, in a mass fraction in the range from 2% to 7%, and v) an accelerator, for example Curezol MZ-A, in a mass fraction in the range from 0.01% to 0.7%.

Also preferred is an eleventh, light-curing adhesive compound of the invention, based on cyclic ether compounds as polymerizable compounds Y, comprising, based on the mass of the adhesive compound: i) a corresponding (meth)acrylate block copolymer X1 of structure A-B-A in a mass fraction in the range from 45% to 60%, ii) an epoxide obtained from the reaction of an alcohol with epichlorohydrin, for example Epikote 828 (liquid) or Araldite GT7072 (solid), in a mass fraction in the range from 15% to 35%, iii) a cycloaliphatic epoxide, for example Uvacure 1500, in a mass fraction in the range from 15% to 35%, iv) an open-time additive, for example polyethylene glycol (Mₙ˜400 g/mol), in a mass fraction in the range from 0.5% to 10%, and v) a photoinitiator, for example a triarylsulfonium antimonate salt, in a mass fraction in the range from 0.3% to 2%.

Also preferred is a twelfth, light-curing adhesive compound of the invention, based on cyclic ether compounds as polymerizable compounds Y, comprising, based on the mass of the adhesive compound: i) a corresponding (meth)acrylate block copolymer X1 of structure A-B-A in a mass fraction in the range from 25% to 50%, ii) an epoxide obtained from the reaction of an alcohol with epichlorohydrin, for example Epikote 828 (liquid) or Araldite GT7072 (solid), in a mass fraction in the range from 15% to 45%, iii) a cycloaliphatic epoxide, for example Uvacure 1500, in a mass fraction in the range from 15% to 45%, iv) an open-time additive, for example polyethylene glycol (Mₙ˜400 g/mol), in a mass fraction in the range from 0.5% to 10%, and v) a photoinitiator, for example a triarylsulfonium antimonate salt, in a mass fraction in the range from 0.3% to 2%.

Also preferred is a thirteenth, light-curing adhesive compound of the invention, based on cyclic ether compounds as polymerizable compounds Y, comprising, based on the mass of the adhesive compound: i) a corresponding (meth)acrylate block copolymer X1 of structure A-B-A in a mass fraction in the range from 20% to 50%, ii) an epoxide obtained from the reaction of an alcohol with epichlorohydrin, for example Epikote 828 (liquid) or Araldite GT7072 (solid), in a mass fraction in the range from 15% to 35%, iii) a cycloaliphatic epoxide, for example Uvacure 1500, in a mass fraction in the range from 15% to 35%, iv) an open-time additive, for example polyethylene glycol (Mₙ˜400 g/mol), in a mass fraction in the range from 0.5% to 10%, v) a photoinitiator, for example a triarylsulfonium antimonate salt, in a mass fraction in the range from 0.3% to 2%, and vi) a filler, for example glass beads or Silibeads 5211, in a mass fraction of 30%.

Also preferred is a fourteenth, light-curing adhesive compound of the invention, based on cyclic ether compounds as polymerizable compounds Y, comprising, based on the mass of the adhesive compound: i) a corresponding (meth)acrylate block copolymer X1 of structure A-B-A in a mass fraction in the range from 20% to 50%, ii) a liquid epoxide, for example bisphenol A diglycidyl ether (e.g. Epikote 828) or cycloaliphatic epoxides (e.g. Uvacure 1500), in a mass fraction in the range from 10% to 45%, iii) a solid epoxide, for example bisphenol A diglycidyl ether (e.g. Araldite GT7072) or epoxy-cresol or epoxy phenol novolacs (e.g. Araldite ECN 1273), in a mass fraction in the range from 10% to 45%, iv) an open-time additive, for example polyethylene glycol (Mₙ˜400 g/mol), in a mass fraction in the range from 0.5% to 10%, and v) a photoinitiator, for example a triarylsulfonium antimonate salt, in a mass fraction in the range from 0.3% to 2%, and optionally vi) a polyol, for example polycaprolactone (e.g. Capa2000), in a mass fraction in the range from 5% to 15%.

Curable adhesive compounds of the invention can be used for example directly as adhesive compounds, and depending on the application method they can also be provided, for example, in the form of tapes. With regard to very favourable handling properties, particularly advantageous results are generally achieved, however, when curable adhesive compounds of the invention are used as an adhesive layer of a single- or double-sided adhesive tape which also comprises a carrier layer. The invention thus also relates to an adhesive tape, in particular reactive adhesive tape, comprising as adhesive layer a curable adhesive compound of the invention, wherein the adhesive tape preferably comprises a carrier layer.

The term adhesive tape is clear to the skilled person in the field of adhesive technology. In the context of the present invention, the expression “tape” refers to all thin, flat structures, i.e. structures with a predominant extent in two dimensions, more particularly films, film portions and labels, preferably tapes with extended length and limited width, and corresponding tape portions.

The carrier layer usually refers to the layer of such a multilayer adhesive tape that significantly determines the mechanical and physical properties of the adhesive tape, such as the tear resistance, stretchability, insulation capacity or restoring capacity. Common materials for the carrier layer are, for example, woven fabrics, laid scrims and polymeric films, for example PET films and polyolefin films. However, the carrier layer can also be pressure-sensitively adhesive itself. The adhesive tape of the invention may in a preferred embodiment be a double-sided adhesive tape whose carrier layer is provided on both sides with a curable adhesive compound of the invention.

In adhesive tapes of the invention, the adhesive layers can be covered with a so-called release liner to allow trouble-free unwinding and to protect the pressure-sensitive adhesive against contamination. Such release liners usually consist of a one- or two-sidedly siliconized polymeric film (e.g. PET or PP) or a siliconized paper carrier.

Also disclosed, on the basis of the curable adhesive compound of the invention and the adhesive tape of the invention, is the use of a curable adhesive compound of the invention or an adhesive tape of the invention for bonding two or more components by curing of the curable adhesive compound.

Also disclosed, finally, is a method for producing a curable adhesive compound of the invention, comprising the method steps of:
a) producing or providing an A monomer composition of A monomers,
b) polymerizing the A monomer composition using a RAFT initiator to obtain an A poly(meth)acrylate,
c) producing or providing a B monomer composition of B monomers,
d) mixing the A poly(meth)acrylate with the B monomer composition and copolymerizing the mixture to obtain a (meth)acrylate block copolymer X of structure A-B-A, and
e) mixing the (meth)acrylate block copolymer X with one or more polymerizable compounds Y and one or more initiators, and optionally one or more further additives, to obtain the curable adhesive compound,
wherein the polymerization in method step b) and the copolymerization in method step d) takes place by means of RAFT polymerization.

In the light of the above disclosure, it is clear to the skilled person that the invention also relates to two specific aspects, each of which is of central importance to the invention and to which the above disclosures on preferred curable adhesive compounds apply accordingly.

The first aspect concerns a curable adhesive compound comprising, based on the mass of the curable adhesive compound:
a) one or more (meth)acrylate block copolymers X of structure A-B-A in a combined mass fraction of 20% or more, wherein the A blocks independently of each other are a poly(meth)acrylate having a glass transition temperature Tg of 50° C. or more, which is producible by polymerization of an A monomer composition of A monomers, wherein the B block is a poly(meth)acrylate having a glass transition temperature Tg of less than 50° C., which is producible by polymerization of a B monomer composition of B monomers, and
b) one or more polymerizable epoxy compounds Y, more particular epoxy resins, in a combined mass fraction of 20% or more, and
wherein the polar fractions, weighted for amount of substance, of the Hansen solubility parameters <δₚ>:
i) of the monomer units derived from A monomers in the A blocks <δₚ>(A),
ii) of the monomer units derived from B monomers in the B block <δₚ>(B), and
iii) of the polymerizable epoxy compounds Y <δₚ>(Y), are subject to:

$$\vert 〈 {δ}_{p} 〉 ( A ) - 〈 {δ}_{p} 〉 ( Y ) \vert > 3.5 {MPa}^{0.5} , and \\ \vert 〈 {δ}_{p} 〉 ( B ) - 〈 {δ}_{p} 〉 ( Y ) \vert < 3.5 {MPa}^{0.5} .$$

The second aspect concerns a curable adhesive compound comprising, based on the mass of the curable adhesive compound:
a) one or more (meth)acrylate block copolymers X of structure A-B-A in a combined mass fraction of 20% or more, wherein the A blocks independently of each other are a poly(meth)acrylate having a glass transition temperature Tg of 50° C. or more, which is producible by polymerization of an A monomer composition of A monomers, wherein the B block is a poly(meth)acrylate having a glass transition temperature Tg of less than 50° C., which is producible by polymerization of a B monomer composition of B monomers, and
b) one or more polymerizable (meth)acrylate monomers Y in a combined mass fraction of 20% or more, and wherein the polar fractions, weighted for amount of substance, of the Hansen solubility parameters <δₚ>:
i) of the A monomers in the A monomer composition <δₚ>(A),
ii) of the B monomers in the B monomer composition <δₚ>(B), and
iii) of the polymerizable (meth)acrylate monomers Y <δₚ>(Y), are subject to:

$$\vert 〈 {δ}_{p} 〉 ( A ) - 〈 {δ}_{p} 〉 ( Y ) \vert > 3.5 {MPa}^{0.5} , and \\ \vert 〈 {δ}_{p} 〉 ( B ) - 〈 {δ}_{p} 〉 ( Y ) \vert < 3.5 {MPa}^{0.5} .$$

Preferred embodiments of the invention are further explained and described below, with reference to experiments.

### A. Production of the (Meth)Acrylate Block Copolymers X of Structure A-B-A:

### General Experimental Conditions:

Reactions were performed under nitrogen atmosphere at room temperature (25° C.) in an EPA threaded bottle with a volume of 60 ml. The radiation source was two Skymore 110 W UV LED nail dryer lamps with a power of 110 W each and an emitted wavelength of 365 nm, which were arranged so that the reaction vessel could be placed at a distance of 2 cm from the LEDs.

### Synthesis of Homopolymers (HP1 to HP4) and Comparative Copolymer (CP1):

For the synthesis of the homopolymers HP1 to HP4 and CP1, a mixture of DBTTC (S,S-dibenzyl trithiocarbonate), IBOA (isobornyl acrylate) (and for CP1 also BA; n-butyl acrylate) and toluene was homogenized according to the details in Table 4 and then flushed with nitrogen for 10 min. The RAFT polymerization was initiated by UV irradiation of the reaction mixture. To end the reaction, the irradiation was interrupted and the highly viscous reaction mixture was dissolved in THF and precipitated dropwise in an excess of cold methanol, and the resulting precipitate was filtered. The homopolymers (HP1 to HP4) isolated in this way can be converted as macro-iniferters by chain extension to block copolymers, whereas CP1 serves as a comparative polymer. Information on the homopolymers obtained is compiled in Table 4.

TABLE 4
Overview of homopolymers (HP1 to HP4)
and comparative copolymer (CP1)

| | c_{IBOA}⁰/ | c_{BA}⁰/ | c_{DBTTC}⁰/ | c_{Monomer}⁰/ | Time/ | Conversion/ |
|---|---|---|---|---|---|---|
| | mol l⁻¹ | mol l⁻¹ | 10⁻² mol l⁻¹ | c_{DBTTC}⁰ | h | % |
| HP1 | 3.79 | 0 | 1.11 | 341 | 4.1 | 84 |
| HP2 | 3.79 | 0 | 0.36 | 1053 | 4.2 | 73 |
| HP3 | 3.79 | 0 | 1.11 | 341 | 4.0 | 88 |
| HP4 | 3.79 | 0 | 0.32 | 1184 | 6.8 | 77 |
| CP1 | 3.89 | 1.14 | 1.03 | 4883 | 9.0 | 96 |

### Synthesis of (Meth)Acrylate Block Copolymers (P1 to P4):

The concentrations as indicated in Table 5 of the macro-iniferter and butyl acrylate were dissolved in toluene and flushed with nitrogen for 10 min. The polymerization was then initiated by turning on the radiation source. The reaction mixture was dissolved in toluene after completion of irradiation. With the help of an automatic film-drawing device, the solution was coated onto a siliconized PET film and freed from toluene and the remaining monomer at 120° C. in the oven for 20 min, thus affording the ABA triblock copolymer. Information on the (meth)acrylate block copolymers obtained is compiled in Table 5.

TABLE 5
Overview of (meth)acrylate block copolymers (P1 to P4)

| | | c_{BA}⁰/ | c_{Iniferter}⁰/ | c_{BA}⁰/ | Time/ | Conversion/ |
|---|---|---|---|---|---|---|
| Abbreviation | Iniferters | mol l⁻¹ | 10⁻² mol l⁻¹ | c_{Iniferter}⁰ | h | % |
| P1 | HP1 | 4.56 | 7.33 | 622 | 8.7 | 97 |
| P2 | HP2 | 5.56 | 2.29 | 2428 | 4.1 | 82 |
| P3 | HP3 | 5.56 | 14.7 | 378 | 9.0 | 96 |
| P4 | HP4 | 5.56 | 5.7 | 975 | 6.5 | 90 |

The A blocks of the (meth)acrylate block copolymers P1 to P4 of IBOA (δp=6.10 MPa^{0.5}) and the monomer units derived from them in CP1 have the required minimum polarity distances from the reactive resins used (5.88 MPa^{0.5} for epoxycyclohexylmethyl 3′,4′-epoxycyclohexanecarboxylate and 3.87 MPa^{0.5} for HPPA).

The B blocks of the (meth)acrylate block copolymers P1 to P4 of BA (δp=8.60 MPa^{0.5}) and the monomer units derived from them in CP1, on the other hand, have a small distance in polarity to the reactive resins used (3.38 MPa^{0.5} for epoxycyclohexylmethyl 3′,4′-epoxycyclohexanecarboxylate and 1.37 MPa^{0.5} for HPPA).

As an additional comparative polymer (CP2), a commercially available (meth)acrylate block copolymer (Kurarity LA2250) was used in which the A blocks of MMA (methyl methacrylate; δp=9.31 MPa^{0.5}) do not have the required minimum polarity distances from the reactive resins used (2.67 MPa⁰⁵ for epoxycyclohexylmethyl 3′,4′-epoxycyclohexanecarboxylate and 0.66 MPa^{0.5} for HPPA). The properties of the polymers used are summarized in Table 6 below.

TABLE 6
Properties of polymers

| | | | | Mass | |
|---|---|---|---|---|---|
| | | A | B | fraction A | Mn/ |
| Abbreviation | Type | monomer | monomer | block/% | (g/mol) |
| P1 | Block | Isobornyl | Butyl | 30 | 150000 |
| | copolymer | acrylate | acrylate | | |
| P2 | Block | Isobornyl | Butyl | 30 | 370000 |
| | copolymer | acrylate | acrylate | | |
| P3 | Block | Isobornyl | Butyl | 45 | 100000 |
| | copolymer | acrylate | acrylate | | |
| P4 | Block | Isobornyl | Butyl | 45 | 220000 |
| | copolymer | acrylate | acrylate | | |
| CP1 | Statistical | Isobornyl | Butyl | 30 | 330000 |
| | | acrylate | acrylate | | |
| CP2 | Block | Methyl | Butyl | 30 | ~50000 |
| | copolymer | methacrylate | acrylate | | |

Adhesive compounds were obtained from the polymers by mixing with the other components in the usual manner. The composition of the adhesive compounds is summarized in Table 7. Adhesive tapes with a thickness of about 100 μm were produced from the adhesive compounds by coating out and evaporation of the solvent.

TABLE 7
Composition of adhesive compounds and solvents, all data in parts by weight

| | E1 | E2 | E3 | E4 | E5 | V1 | V2 |
|---|---|---|---|---|---|---|---|
| P1 | 50 | | | | 50 | | |
| P2 | | 50 | | | | | |
| P3 | | | 50 | | | | |
| P4 | | | | 50 | | | |
| CP1 | | | | | | 50 | |
| CP2 | | | | | | | 50 |
| 3,4-Epoxycyclohexylmethyl 3′,4′- | 50 | 50 | 50 | 50 | | 50 | 50 |
| epoxycyclohexanecarboxylate | | | | | | | |
| Hydroxyphenylpropyl acrylate | | | | | 47.5 | | |
| Triarylsulfonium hexafluoroantimonate | 1 | 1 | 1 | 1 | | 1 | 1 |
| (CAS: 109037-75-4) | | | | | | | |
| Peroxan IHP (50% solution of | | | | | 2.5 | | |
| diisopropylbenzene hydroperoxide | | | | | | | |
| (CAS: 26762-93-6) in | | | | | | | |
| diisopropylbenzene) | | | | | | | |
| Ru(bipy)₃ Cl₂ hexahydrate | | | | | 0.03 | | |
| (CAS: 50525-27-4) | | | | | | | |
| Acetone | 100 | 100 | 100 | 100 | 100 | 100 | 100 |

### B. Bonding Experiments:

The peel adhesion properties were determined in analogy to ISO 29862 (Method 3) at 23° C. and 50% relative humidity at a peeling speed of 300 mm/min and a peel angle of 180°. The thickness of the adhesive layer was 100 μm in each case. An etched PET film of 50 μm in thickness such as is obtainable from Coveme (Italy) was used as reinforcing film. Steel plates according to the standard were used as substrate. The uncured measuring strip was bonded using a roll-on machine with 4 kg at a temperature of 23° C. The adhesive tapes were peeled off immediately after application. The measured value (in N/cm) was the average of three individual measurements and the failure mode was documented as follows: adhesive failure (A) or cohesive failure (C).

In addition, the tensile shear strength was determined on the cured adhesive compounds. The bond strength was determined in each case quantitatively in a dynamic tensile shear test in accordance with DIN-EN 1465 at 23° C. and 50% relative humidity for a test speed of 1 mm/min (results in N/mm²=MPa). The test rods used were made of steel, and were cleaned with acetone before bonding. The layer thicknesses of the adhesive tapes corresponded in each case to the above specifications. The adhesive tapes were irradiated with suitable light before assembly of the test rods after removal of the second liner and the test specimens were assembled immediately afterwards. The measurement was carried out after 7 days of storage at 23° C. and 50% relative humidity. The average from three measurements is given.

The results of the experiments are summarized in Table 8.

TABLE 8
Summary of the bonding experiments

| | E1 | E2 | E3 | E4 | E5 | V1 | V2 |
|---|---|---|---|---|---|---|---|
| Fracture | A | A | A | A | A | C | C |
| mode*/Peel | (>1 N/cm) | (>1 N/cm) | (>1 N/cm) | (>1 N/cm) | (>1 N/cm) | | |
| adhesion | | | | | | | |
| Tensile shear | 5.5 | 6.0 | 5.1 | 6.7 | 5.3 | 4.6 | 8.2 |
| test/MPa | | | | | | | |

*A: adhesive failure; C: cohesive failure

Based on the fracture mode in the peel adhesion test, the advantageous cohesion-enhancing effect of the (meth)acrylate block copolymers which are used in the adhesive compounds of the invention can be proven.

Although the adhesive compounds contain nearly 50% of a liquid reactive resin, they are sufficiently cohesive to allow adhesive failure as is typical of pressure-sensitive adhesives. In contrast, the comparative examples C1 and C2 show themselves to be pasty non-cohesive adhesive compounds, which split cohesively in the peel adhesion test.

The tensile shear tests after curing show that the adhesive compounds cure and good bonding strengths can be achieved, which indicates a sufficient flow-on behaviour. The advantage of the adhesive compounds of the invention is shown in particular in the positive combination of the properties before and after curing.

1. A curable adhesive compound, comprising, based on the mass of the curable adhesive compound:
a) one or more (meth)acrylate block copolymers X of structure A-B-A in a combined mass fraction of 20% or more,
wherein the A blocks independently of each other are a poly(meth)acrylate having a glass transition temperature Tg of 50° C. or more, which is producible by polymerization of an A monomer composition of A monomers,
wherein the B block is a poly(meth)acrylate having a glass transition temperature Tg of less than 50° C., which is producible by polymerization of a B monomer composition of B monomers, and
b) one or more polymerizable compounds Y in a combined mass fraction of 20% or more, and
wherein the polar fractions, weighted for amount of substance, of the Hansen solubility parameters <δₚ>:
i) of the monomer units derived from A monomers in the A blocks <δₚ>(A),
ii) of the monomer units derived from B monomers in the B block <δₚ>(B), and
iii) of the polymerizable compounds Y <δₚ>(Y),
are subject to:
$$\vert 〈 {δ}_{p} 〉 ( A ) - 〈 {δ}_{p} 〉 ( Y ) \vert > 3.5 {MPa}^{0.5} , and \\ \vert 〈 {δ}_{p} 〉 ( B ) - 〈 {δ}_{p} 〉 ( Y ) \vert < 3.5 {MPa}^{0.5} .$$

2. The curable adhesive compound according to claim 1, wherein the polymerizable compounds Y are selected from the group consisting of epoxy compounds, and (meth)acrylate monomers.

3. The curable adhesive compound according to claim 1, wherein the combined mass fraction of the polymerizable compounds Y in the curable adhesive compound is 30% or more.

4. The curable adhesive compound according to claim 1, wherein the combined mass fraction of the (meth)acrylate block copolymers X in the curable adhesive compound is in the range from 20% to 70%.

5. The curable adhesive compound according to claim 1, wherein the A monomers comprise one or more monomers, selected from the group consisting of (meth)acrylate monomers and (meth)acrylic acid, and/or wherein the B monomers comprise one or more monomers, selected from the group consisting of (meth)acrylate monomers and (meth)acrylic acid.

6. The curable adhesive compound according to claim 5, wherein the A monomers comprise one or more monomers, selected from the group consisting of n-octyl acrylate, 2-ethyhexyl acrylate, propylheptyl acrylate, 2-phenoxyethyl acrylate, isobornyl acrylate, dihydrodicyclopentadienyl acrylate, lauryl acrylate, stearyl acrylate and heptadecyl acrylate.

7. The curable adhesive compound according to claim 1, wherein the two A blocks are poly(meth)acrylates which are producible by polymerization of the same A monomer composition of A monomers, wherein the A blocks are identical.

8. The curable adhesive compound according to claim 5, wherein the B monomers comprise one or more monomers, selected from the group consisting of n-octyl acrylate, 2-ethyhexyl acrylate, hydroxyethyl acrylate, methoxyethyl acrylate, acrylate, 2-phenoxydiethylene glycol acrylate, methyl acrylate, ethyl acrylate, tert-butyl acrylate, n-butyl acrylate, methyl methacrylate and acrylic acid.

9. The curable adhesive compound according to claim 1, wherein the polar fraction, weighted for amount of substance, of the Hansen solubility parameter of the monomer units derived from A monomers in the A blocks <δₚ>(A) is in the range from 0.5 to 7.5 MPa^{0.5}, and/or
wherein the polar fraction, weighted for amount of substance, of the Hansen solubility parameter of the monomer units derived from B monomers in the B block <δₚ>(B) is in the range from 8.0 to 13.0 MPa^{0.5}, and/or
wherein the polar fraction, weighted for amount of substance, of the Hansen solubility parameter of the polymerizable compounds Y in the curable adhesive compound <δₚ>(Y) is in the range from 8.5 to 13.0 MPa^{0.5}.

10. An adhesive tape, comprising as adhesive layer a curable adhesive compound according to claim 1.

11. The curable adhesive composition according to claim 2, wherein the polymerizable compounds Y are selected from the group consisting of epoxy monomers and (meth)acrylate monomers.

12. The curable adhesive composition according to claim 4, wherein the combined mass fraction of the (meth)acrylate block copolymers X in the curable adhesive compound is in the range from 25% to 65%.

13. The curable adhesive composition according to claim 12, wherein the combined mass fraction of the (meth)acrylate block copolymers X in the curable adhesive compound is in the range from 30% to 55%.

14. The curable adhesive composition according to claim 5 wherein the A monomers comprise one monomer selected from the group consisting of (meth)acrylate monomers and (meth)acrylic acid, and/or wherein the B monomers comprise one monomer selected from the group consisting of (meth)acrylate monomers and (meth)acrylic acid.

15. The curable adhesive composition according to claim 14 wherein the A monomer is selected from the group consisting of n-octyl acrylate, 2-ethyhexyl acrylate, propylheptyl acrylate, 2-phenoxyethyl acrylate, isobornyl acrylate, dihydrodicyclopentadienyl acrylate, lauryl acrylate, stearyl acrylate and heptadecyl acrylate.

16. The curable adhesive composition according to claim 14 wherein the B monomer is selected from the group consisting of n-octyl acrylate, 2-ethyhexyl acrylate, hydroxyethyl acrylate, methoxyethyl acrylate, ethylene diglycol acrylate, 2-phenoxydiethylene glycol acrylate, methyl acrylate, ethyl acrylate, tert-butyl acrylate, n-butyl acrylate, methyl methacrylate and acrylic acid.

17. The curable adhesive compound according to claim 3, wherein the combined mass fraction of the polymerizable compounds Y in the curable adhesive compound is 40% or more.

18. The adhesive tape, comprising as adhesive layer a curable adhesive compound according to claim 9.
